(19) United States
(12) Patent Application Publication
(10) Pub. No.: US 2015/0328986 A1
(43) Pub. Date: Nov. 19, 2015

(54) METHOD FOR OPERATING A VEHICLE

(71) Applicant: Stefan Nordbruch, Kornwestheim (DE)

(72) Inventor: Stefan Nordbruch, Kornwestheim (DE)

(21) Appl. No.: 14/342,939

(22) PCT Filed: Jul. 5, 2012
(86) PCT No.: PCT/EP2012/063091

§ 371 Date: Sep. 10, 2014

(30) Foreign Application Priority Data
Sep. 5, 2011 (DE) 10 2011 082 123.6

(51) Int. Cl. B60K 35/00; G01C 21/26

(52) U.S. Cl. CPC B60K 35/00; G01C 21/26

(57) ABSTRACT

A processing unit, a computer program product, and a method for operating a vehicle having a processing unit, including at least one vehicle component, the processing unit of the vehicle sending a query to an external processing unit, the query containing a destination region for the vehicle and information about the vehicle component, the processing unit receiving from the external processing unit information with regard to a restriction in a functionality of the component in the destination region, the processing unit taking the information into account in operating the vehicle, and/or outputting it to a driver. In addition, also described is a method for operating a processing unit, in which the processing unit receives a query from a processing unit of a vehicle, the query including a destination region for the vehicle and information about the vehicle component, and the processing unit checks whether a restriction of a functionality of the component exists in the destination region, and the processing unit transmits information about the existence of a restriction to the processing unit of the vehicle.

### FIELD OF THE INVENTION

The present invention relates to a method for operating a vehicle, a method for operating a processing unit, a computer program product, a processing unit of a vehicle, and to an external processing unit.

### BACKGROUND INFORMATION

Various diagnostic systems for monitoring the operativeness of components of a vehicle are known from the related art. For example, if it is detected that a sensor of a vehicle is not working properly, a corresponding error message is generated and stored in an error memory in the vehicle and/or displayed to the driver.

### SUMMARY

An object of the present invention is to improve a method for operating a vehicle.

One advantage of the method of the present invention is that a restriction of a functionality of a vehicle component is able to be checked with the aid of external data. In this way, a driver is able to check, for instance prior to reaching a destination region, whether at least one specified vehicle component is operating without restriction and/or may be used without restriction in the destination region. For example, this may be advantageous if the travel leads through regions with extreme temperatures or extreme weather conditions. For instance, some components of the vehicle could conceivably be operating only to a limited extent at temperatures that are too high or too low. In addition, extreme weather conditions such as snow, ice, hail and torrential rain can impair the operativeness of vehicle components or even render them nonfunctional.

Furthermore, legal provisions or rules could stipulate that certain components of the vehicle may not be used. Moreover, certain roadway geometries may cause some components of the vehicle, especially driver assistance systems, to function only to a limited extent, or it is possible that they should not be used at all. Using the method described, the operativeness of the components of the vehicle may be checked with the aid of an external processing unit, taking dynamic boundary conditions into account as well.

This is achieved in that the processing unit of the vehicle sends a query to an external processing unit, the query containing a destination region for the vehicle and information about the vehicle component, the processing unit receiving information from the external processing unit about a restriction in a functionality of the component in the destination region, the processing unit taking the information into account in operating the vehicle, and/or outputting it to a driver.

In a further development of the method, an actuator, a sensor, a vehicle system, a driver assistance system or a functionality of the vehicle such as the type and/or manner of drive, is used as component. The umbrella term ‘component’ thus describes any type of element and/or method that is able to be used for operating the vehicle. A comprehensive check of the vehicle, for example, may therefore be carried out.

In a further refinement of the method, the information regarding the restriction transmitted by the external processing unit includes information about the reliable functioning of the component in the destination region. This makes it possible for the processing unit and/or the driver to decide whether the checked component is to be used in the destination region or whether, for instance, the destination region should be bypassed. For example, it may be provided that the operation of an internal combustion engine is prohibited in a specified region such as an urban area, and that the vehicle may be operated using an electric motor exclusively. If the vehicle is not equipped with an electric motor, then the area is bypassed. If the vehicle is equipped with an electric motor, the driver may make a decision, for instance as a function of the electric charge of the battery supplying the electric motor, whether travel through the area is desirable.

In a further specific embodiment, the processing unit additionally supplies a current position of the vehicle with the query. The processing unit may use this information to check, for example, whether an impairment of the functionality of the component is present on the route to the destination region. Depending on the selected specific embodiment, the current location of the vehicle may coincide with the destination region.

In one further specific embodiment, the processing unit of the vehicle receives information about the restriction, which may depend on the weather and/or an ambient temperature and/or legal provisions and/or traffic information and/or a roadway geometry and/or a road property.

In one further specific embodiment, the processing unit of the vehicle additionally transmits with the query a time at which the vehicle will reach the destination region. It is therefore possible for the external processing unit to consider the time as well when checking the restriction of the functionality of the component. For example, legal restrictions that are effective for a destination region may apply only at a particular time. Furthermore, the external processing unit is able to take into account dynamic conditions such as the weather based on forecasts for the indicated time. Depending on the selected specific embodiment, the external processing unit may also calculate the time as a function of the distance between the current location of the vehicle, the destination region, and a medium predefined speed. The analysis of the restriction of the functionality of the component thus becomes more precise.

The external processing unit, for example, has the advantage that access is provided to larger databases, dynamic information such as the weather, temperatures, traffic information, e.g., congestion, detours or construction sites. As a result, the external processing unit is able to provide a processing unit with better information about the operability of a vehicle component. This improves the safety in operating the component and/or the driver's planning with regard to the use of the vehicle component.

The external processing unit preferably considers the current location of the vehicle, which may or may not coincide with the destination region of the vehicle. As a result, the route between the location of the vehicle and the destination region may be taken into account as well when assessing the operability of the component of the vehicle.

### BRIEF DESCRIPTION OF THE DRAWINGS

FIG. 1 a schematic structure of a system for implementing the method.

FIG. 2 a schematic program sequence for implementing the method.

### DETAILED DESCRIPTION

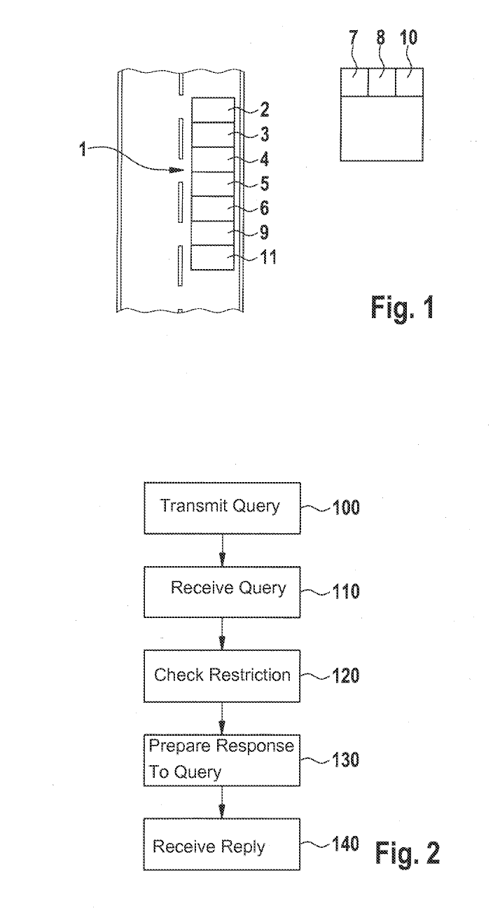

FIG. 1 schematically shows a roadway, on which a vehicle 1 is traveling. Vehicle 1 is equipped with a processing unit 3, which is connected to an interface 2. Interface 2 is developed to transmit and receive data and information in a wireless manner. Moreover, vehicle 1 has sensors 4 and actuators 11, functionalities 5, such as driver assistance systems, and an input/output unit 6. A data memory 9 is provided in addition. Processing unit 3 is in connection with interface 2, sensors 4, functionalities 5, input/output 6, and data memory 9. The sensors, for example, may be radar sensors or video sensors. An injection system of an internal combustion engine, an all-wheel drive, an electric motor, an internal combustion engine, etc. may be used as actuator. Provided as functionality 5, for example, may be a driver assistance functionality such as automatic (vehicle-to-vehicle) ranging, an automatic lane keeping system, etc.

Furthermore, a navigation system having a locating device may be provided as functionality 5 as well. In addition, processing unit 3 has time information available. For example, information about the components of the vehicle is stored in data memory 9. Sensors 4, actuators 11, and functionalities 5 are considered components of the vehicle, for example.

Furthermore, a second, external processing unit 8 is provided, which has a second interface 7. Second processing unit 8 moreover is able to access a second data memory 10. Depending on the selected specific embodiment, a communication link between vehicle 1 and external processing unit 8 is able to be set up directly, such as a radio link, a mobile telephony link, WLAN, and/or LTE. Depending on the selected specific embodiment, a communication link from vehicle 1 to second processing unit 8 is furthermore able to be established via at least one further vehicle.

Using second interface 7, second processing unit 8 may also access additional databases, for instance. In this context the Internet or other information services is/are able to be used to obtain current information about the destination region.

Depending on the selected specific embodiment, interface 2 may also be connected to a communication device that is situated inside vehicle 1. For example, the communication device may be embodied as mobile telephone, especially as smartphone, or as PC having the capability of establishing a communication link. In this case, processing unit 3 is able to set up a connection to the external processing unit and/or to another vehicle via the communication device.

FIG. 2 shows a method for operating a vehicle with a processing unit, in which processing unit 3 of vehicle 1 transmits a query to external processing unit 8 via second interface 7, at program point 100. For example, the query may be started automatically, by processing unit 3 or by way of an operator input, via input/output 6. In the query, processing unit 3 transmits an identification for a component of the vehicle and a destination region for the vehicle. The destination region may be at a distance from the current location of the vehicle, or else may coincide with it. The information about the vehicle component unambiguously identifies the component of the vehicle.

In a following program point 110, second processing unit 8 receives the query from processing unit 3 of vehicle 1 via second interface 7. Because of the identification of the vehicle component, second processing unit 8 is able to identify the vehicle component, or at least the type of vehicle component. Corresponding assignments between the identification and the vehicle components or the types of vehicle components are stored in second data memory 10 for this purpose. Furthermore, it is possible that rules and/or regulations with regard to the operability or the permission to use the vehicle components for specified ambient conditions and/or stipulated local regions are stored in second data memory 10. Moreover, algorithms, calculation methods and/or tables may be stored in data memory 10, in which a restriction of a functionality of the component as a function of specified parameters and/or regions is stored. Specified parameters that are stored, for example, may be temperatures, weather conditions, traffic conditions, roadway geometries, etc.

In a following program point 120, second processing unit 8 checks whether a restriction of the functionality of the vehicle component is specified for the transmitted vehicle component or may be possible for the transmitted destination region. Logical comparisons or rules may also be stored in second data memory 10 for this check. To check the restriction of the vehicle component, second processing unit 8 may access not only the data in second data memory 10, but also additional databases, for instance via the Internet. The following conditions may be taken into account in this context: the temperature, weather conditions, traffic information, legal stipulations, etc.

In a following program point 130, second processing unit 8 prepares a response to the query of processing unit 3, and transmits it via second interface 7 to first interface 2 of processing unit 3. The response contains the information whether the queried component is able to be used in the destination region, may be used with restrictions, and/or is not permitted.

In a following program point 140, processing unit 3 receives the reply from second processing unit 8. Processing unit 3 may consider the reply in the vehicle operation, in particular in the operation of the queried vehicle component, and/or it may output a corresponding message to the driver. For example, the use of a vehicle component such as an actuator, a sensor, a vehicle system, a functionality such as driver assistance systems, may be restricted and/or banned as a function of the response of second processing unit 8. Depending on the specific embodiment selected, the response of second processing unit 8 may already include a specification for the use, the restricted use, or a ban on the use of the component. Moreover, the response from second processing unit 8 may also include a value that is analyzed by processing unit 3 according to specified inputs, in order to restrict or completely ban the use of a component. In the simplest case, a comparison with a threshold value may be utilized for this purpose. If the value transmitted with the response from second processing unit 8 exceeds the first threshold value, then restricted use of the component is implemented by processing unit 3. If, for example, the parameter exceeds a second, higher threshold value, then the use of the component will be prevented completely by processing unit 3. In the least complicated case, it is also possible to use only one threshold value, whose exceeding means that the component will not be used.

In another specific embodiment, in addition to a destination region such as a county, an urban area or an individually specified region, the query of processing unit 3 at program point 100 may also include information about the current location of the vehicle. In this specific embodiment, in addition to information about a restriction of a functionality of the component in the destination region, second processing unit 8 may also provide information about a restriction of the functionality between the current location and the destination region. Accordingly, processing unit 3 may already take possible impairments and/or restrictions or bans of the component into account while traveling from the current location to the destination region, and/or it may display such information to the driver.

Moreover, the restriction of a functionality of a component may also depend on a roadway geometry in the destination region. For example, towing a trailer on a steep mountain pass while having low engine capacity may be stipulated as a restriction or ban of the component for towing a trailer. Moreover, narrow roads, for example, may constitute a prohibition for an excessively broad vehicle, such as a light truck or trailer truck.

In a further specific embodiment, the query from processing unit 3 to second processing unit 8 may include information about the time at which the vehicle will reach the destination region. When checking a restriction of a functionality of the component, second processing unit 8 is able to consider the time accordingly. Appropriate specifications, restrictions, and rules or information regarding the weather as a function of the time may be available to second processing unit 8 for this purpose.

1.-13. (canceled)

14. A method for operating a vehicle having a processing unit, including at least one vehicle component, comprising:
sending, by the processing unit of the vehicle, a query to an external processing unit, the query containing a destination region for the vehicle and information about the component; and
receiving, by the processing unit, from the external processing unit information regarding a restriction of a functionality of the component in the destination region, the processing unit taking the information into account in at least one of operating the vehicle and outputting the information to a driver.

15. The method as recited in claim 14, wherein the component includes at least one of an actuator, a sensor, a vehicle system, a functionality of the vehicle, a type of drive used, and a manner of use of the drive.

16. The method as recited in claim 14, wherein the information about the restriction includes information about a reliable functioning of the component in the destination region.

17. The method as recited in claim 14, wherein:
the processing unit transmits a current position of the vehicle in the query,
the processing unit receives from the external processing unit information about a restriction of a functionality of the component on a route from a current location to the destination region, and
the information is taken into account by the processing unit in operating the vehicle.

18. The method as recited in claim 14, wherein the restriction is a function of at least one of weather, an ambient temperature, a legal provision, traffic information, a roadway geometry, and a roadway characteristic.

19. The method as recited in claim 14, wherein the processing unit transmits a time with the query, at which the vehicle will reach the destination region, and wherein the processing unit receives from the external processing unit second information about a restriction of a functionality of the component at the indicated time in the destination region, the second information being taken into account by the processing unit in operating the vehicle.

20. The method as recited in claim 14, wherein the processing unit includes an input/output arrangement, wherein an operator one of inputs the query and at least starts the query.

21. A method for operating a processing unit, comprising:
receiving by a processor a query from a processing unit of a vehicle, the query including a destination region for the vehicle and information about a vehicle component;
checking by the processing unit whether a restriction of a functionality of the component exists in the destination region; and
transmitting by the processing unit information about an existence of the restriction to the processing unit of the vehicle.

22. The method as recited in claim 21, wherein:
the query additionally includes a current location of the vehicle,
the processing unit checks whether a restriction of a functionality of the component on a route from the current location of the vehicle to the destination region exists, and
the processing unit transmits a result of the check to the processing unit of the vehicle.

23. The method as recited in claim 21, wherein:
the query includes a time at which the vehicle will reach the destination region,
the processing unit checks whether the restriction of the functionality of the component exists in the destination region at the indicated time, and
the processing unit transmits a result of the check to the processing unit of the vehicle.

24. A computer program product having a program code designed to implement a method when the method is run on a processing unit, the method being for operating a vehicle having the processing unit, including at least one vehicle component, and comprising:
sending, by the processing unit of the vehicle, a query to an external processing unit, the query containing a destination region for the vehicle and information about the component; and
receiving, by the processing unit, from the external processing unit information regarding a restriction of a functionality of the component in the destination region, the processing unit taking the information into account in at least one of operating the vehicle and outputting the information to a driver.

25. A processing unit of a vehicle for implementing a method when the method is run on the processing unit, the method being for operating a vehicle having the processing unit, including at least one vehicle component, and comprising:
sending, by the processing unit of the vehicle, a query to an external processing unit, the query containing a destination region for the vehicle and information about the component; and
receiving, by the processing unit, from the external processing unit information regarding a restriction of a functionality of the component in the destination region, the processing unit taking the information into account in at least one of operating the vehicle and outputting the information to a driver.

26. A processing unit for implementing a method for operating a processing unit, comprising:
receiving by a processor a query from a processing unit of a vehicle, the query including a destination region for the vehicle and information about a vehicle component;
checking by the processing unit whether a restriction of a functionality of the component exists in the destination region; and
transmitting by the processing unit information about an existence of the restriction to the processing unit of the vehicle.
